(19) United States
(12) Patent Application Publication
(10) Pub. No.: US 2007/0295177 A1
(43) Pub. Date: Dec. 27, 2007

(54) CONTINUOUS PAPER CUTTING APPARATUS AND CONTINUOUS PAPER CUTTING METHOD

(75) Inventors: Hiroyuki Taguchi, Kawasaki-shi (JP); Kiyotaka Nihashi, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/755,877

(22) Filed: May 31, 2007

(30) Foreign Application Priority Data
Jun. 26, 2006 (JP) 2006-175502

(51) Int. Cl. B23Q 15/013

(52) U.S. Cl. 83/73

(57) ABSTRACT

Slits are provided in a position detection gear for driving a cutter. When the position detection sensor has sensed from the detection of the slits of the position detection gear that the cutter is in a cutting termination position, a control unit operates a conveyance mechanism in the direction in which the continuous paper is withdrawn from the cutter. This ensures that withdrawal of the continuous paper from the cutter occurs at an appropriate timing. In the case where a stepping motor is adopted as a motor for driving the cutter, the following configuration can be used. Whether the cutter is in the cutting-termination position or not is detected from the number of steps by which the stepping motor is driven.

### BACKGROUND OF THE INVENTION

1. Field of the Invention

The present invention relates to a continuous paper cutting apparatus and a continuous paper cutting method, and more particularly to a cutting apparatus and a continuous paper cutting method that control a continuous paper position in relation to a cutter position when cutting the continuous paper.

2. Description of the Related Art

In conventional cutting apparatuses for continuous paper, the continuous paper remains in the cut position even after it is cut. Accordingly, there is a case where the cutter touches the surface of the continuous paper when the cuter returns to its initial position, with the result that the cutter blade scraps the surface of the continuous paper, giving rise to the problem that paper dust is generated.

In order to overcome this problem, it is necessary to control the cutter position and the continuous paper position. Below are examples of the technology related to this problem.

According to an example of such a technology, a cutting apparatus using a rotary cutter includes: a plurality of magnetic projections on a disk so disposed as to be concentric with a rotary blade, and a detector for detecting the magnetic projection. Using the detector, the cutting apparatus detects the stopped position of the rotary blade, and controls the timing of rotation of the rotary cutter (refer to Japanese Patent Application Laid-Open No. 7-49195).

According to another example, a cutting apparatus using a rotary cutter includes a time measuring means incorporated in the cutter drive device. The means measures the time taken from the initiation of cutting paper to the termination of cutting paper. Then, from the measured length of time, the cutting apparatus calculates the timing for braking the rotary blade. Then, with the timing calculated, a brake is applied to the motor for driving the cutter (refer to Japanese Patent Application Laid-Open No. 6-133576).

However, neither of the above controls the cutter position and the continuous paper position or solves the problem of paper dust produced by contact of the cutter blade with paper.

### BRIEF SUMMARY OF THE INVENTION

It is an object of the present invention to provide a continuous paper cutting apparatus and a continuous paper cutting method, which avoid cutter blade's scraping a paper surface and producing paper dust.

In an aspect of the present invention, a continuous paper cutting apparatus includes: a cutter which cuts continuous paper; a conveyance mechanism which conveys the continuous paper to the cutter; a position detection gear which rotates in synchronization with the cutter; a position detection sensor which detects the position of the cutter based on the rotated position of the position detection gear; and a control unit which controls the conveyance mechanism so as to withdraw the continuous paper from the cutter when the position detection sensor detects that the cutter is in a cutting termination position.

### DESCRIPTION OF THE DRAWINGS

FIG. 1A is a view showing a configuration example that includes a cutting apparatus according to a first embodiment of the invention.

FIG. 1B illustrates the state of a position detection sensor 110 when detecting a cutting-termination detecting slit 109.

FIG. 2A is an enlarged view of a cutter in the state illustrated in FIG. 1A.

FIG. 2B is a perspective view of the cutter in FIG. 2A.

FIG. 3A is an enlarged view of the cutter in the state illustrated in FIG. 1B.

FIG. 3B is a perspective view of the cutter in FIG. 3A.

FIG. 4A illustrates the state in which the cutting apparatus of the first embodiment conveys continuous paper before cutting.

FIG. 4B illustrates the state in which the cutting apparatus of the first embodiment has started cutting the continuous paper.

FIG. 4C illustrates the state in which the cutting apparatus of the first embodiment has terminated cutting the continuous paper 405.

FIG. 5 is a view schematically showing a configuration example in which a movable blade is disposed above the continuous paper and a fixed blade below the continuous paper.

FIG. 6 is a block diagram showing a control device for the cutting apparatus of the first embodiment.

FIG. 7 is a flowchart illustrating a cutter position initialization process performed by the cutting apparatus of the first embodiment.

FIG. 8 is a flowchart illustrating a continuous paper cutting process performed by the cutting apparatus of the first embodiment.

FIG. 9 is a flowchart illustrating a cutter position initialization process performed by a cutting apparatus of a second embodiment.

FIG. 10 is a flowchart illustrating a continuous paper cutting process performed by the cutting apparatus of the second embodiment.

### DETAILED DESCRIPTION OF THE INVENTION

Throughout this description, the embodiments and examples shown should be considered as exemplars, rather than limitations on the apparatus and methods of the present invention.

Referring to the accompanying drawings, there will be described preferred embodiments of continuous paper cutting apparatuses and methods according to the present invention.

### First Embodiment

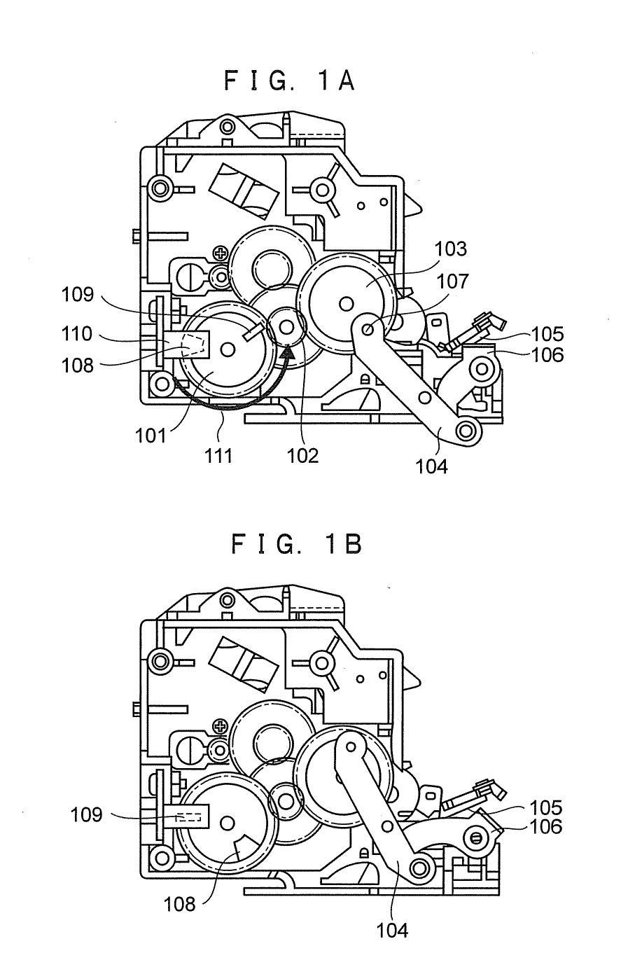

FIG. 1A is a view showing a configuration example that includes a cutting apparatus according to a first embodiment of the invention.

The continuous paper cutting apparatus according to the first embodiment of the invention includes: a position detection gear 101, which has two or more slits the widths of which differ in the rotating direction of the gear 101 and which is rotatable in order to detect the position of a cutter; a gear 102, which transmits rotation of the position detection gear 101 at a reduced speed and in opposite rotating direction; a cutter drive gear 103 rotated by the gear 102; a cutter drive arm 104, one end of which is connected to the cutter drive gear 103 by a lock pin 107 such that the cutter drive arm 104 is rotatable, thereby driving the cutter; a movable blade 106, which is connected rotatably to the cutter drive arm 104 and reciprocally driven by the cutter drive arm 104; a fixed blade 105, which cuts paper together with the movable blade 106; and a position detection sensor 110, which detects the position of the blade 106 based on the position of detection gear 101.

The position detection gear 101 has two or more slits, the widths of which differ in the rotating direction of the gear 101. The continuous paper cutting apparatus of the present invention includes a first slit, namely an initial-position detecting slit 108, which is wider in the rotating direction, and a second slit, namely a cutting-termination detecting slit 109, which is narrower in the rotating direction. In the FIG. 1A, the initial-position detecting slit 108, obscured by the position detection sensor 110, is indicated by a dotted line. In this case, the slits are openings through which light passes.

The position detection sensor 110 has a light source that emits light onto one face of the position detection gear 101, and on the opposite side is a detector that detects light emitted from the light source. When the initial-position detecting slit 108 or cutting-termination detecting slit 109 passes the detector, the position detection sensor 110 detects the passage of the slit and measures the time taken by the slit to pass. From the time taken by the slit to pass, the sensor 110 measures the width of the slit, and determines whether the slit detected is the initial-position detecting slit 108 or cutting-termination detecting slit 109. In addition, the position detection sensor 110 may detect the rotating speed of the position detection gear 101 by measuring the time from the flashing on to flashing off of the light. Thus, the position detection sensor 110 of the continuous paper cutting device of the present invention detects the position of the movable blade 106, based on the rotated position of the position detection gear 101.

Further, the continuous paper cutting device according to the first embodiment of the present invention includes: a conveyance mechanism (not shown), which conveys continuous paper to the cutter; a tensioning unit (not shown) located on the side where the continuous paper will be ejected once cut, and used to apply tension to the continuous paper; and a drive motor (not shown), which drives the position detection gear 101. The present invention adopts a DC motor as the drive motor.

The operation of the continuous paper cutting apparatus will now be described.

Upon the rotation of the drive motor, the rotation is transmitted to the position detection gear 101, the position detection gear 101 rotates in the direction of the arrow 111, and consequently rotates the cutter drive gear 103 via the gear 102. In response to the rotation of the cutter drive gear 103, the cutter drive arm 104 is pulled up and, thus, the movable blade 106 repeats the cycle of cutting and returning to the initial position.

Referring to FIG. 1A, the position detection sensor 110 is in the state of detecting the initial-position detecting slit 108. In this state, the movable blade 106 is in the initial position, in which it initiates cutting.

When the position detection gear 101 rotates in the direction of the arrow 111, the movable blade 106 initiates cutting the continuous paper. While the continuous paper is being cut, the conveyance of the continuous paper is stopped. When the position detection gear 101 rotates to the position where the position detection sensor 110 detects the cutting-termination detecting slit 109, the movable blade 106 terminates the cutting of the continuous paper.

Referring to FIG. 1B, the position detection sensor 110 is in the state of detecting the cutting-termination detecting slit 109. In this state, the movable blade 106 is in the position where the blade 106 has terminated cutting the continuous paper.

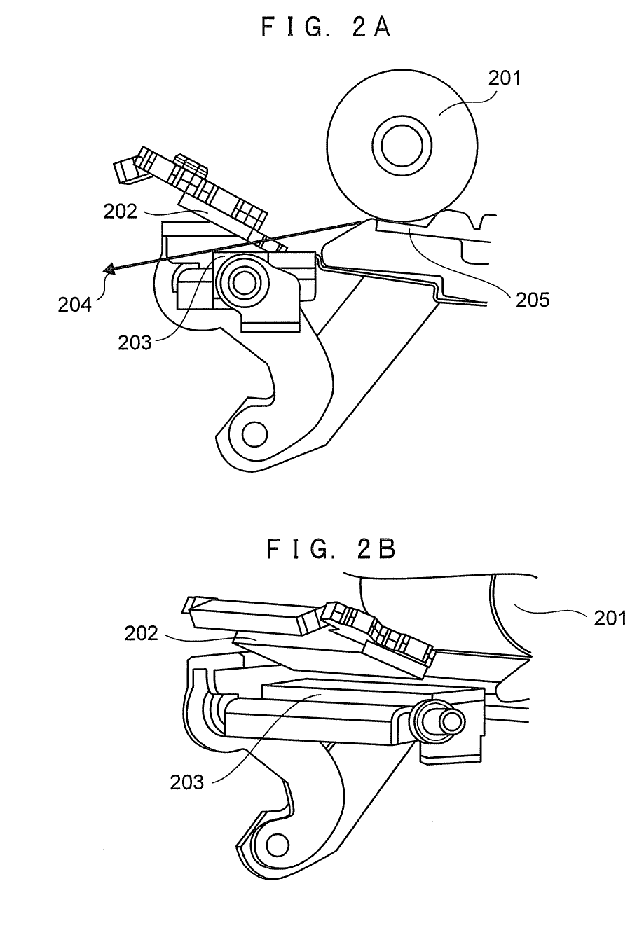

FIG. 2A is an enlarged view of a cutter portion in the state shown in FIG. 1A. FIG. 2B is a perspective view of the cutter portion. Reference numbers 202 and 203 denote the fixed blade and movable blade respectively. In addition, the first embodiment adopts a platen 201 as the conveyance mechanism. The reference number 205 denotes a thermal head used for printing.

The continuous paper is passed between the platen 201 and thermal head 205, and conveyed in the direction of the arrow 204 between the fixed blade 202 and movable blade 203 by the rotation of the platen 201. In FIGS. 2A and 2B, the movable blade 203 is in the initial position.

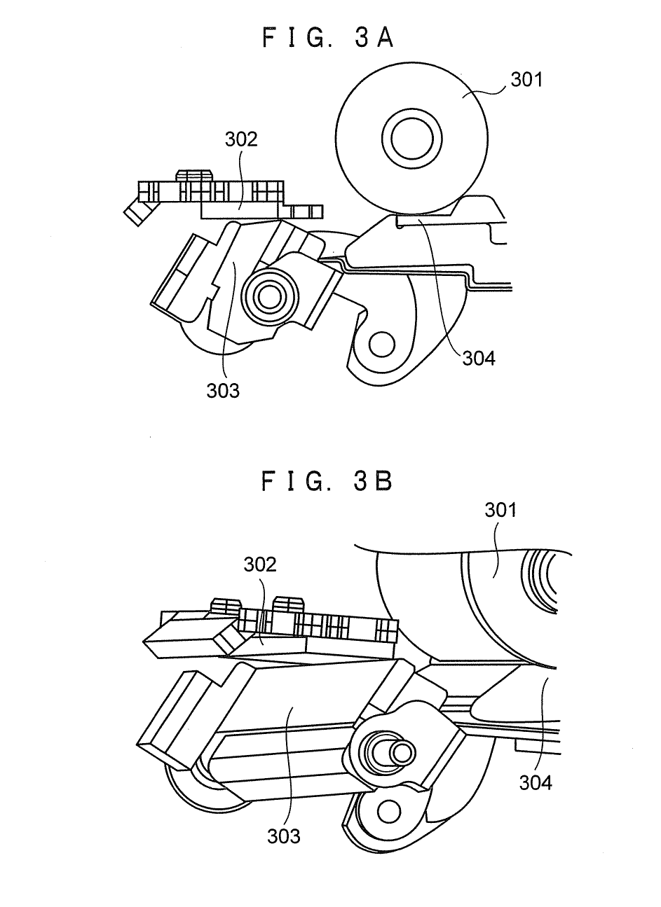

FIG. 3A is an enlarged view of the cutter portion in the state shown in FIG. 1B. FIG. 3B is a perspective view of the cutter portion. In FIGS. 3A and 3B, the continuous paper is not shown. Reference numbers 302 and 303 denote the fixed blade and movable blade respectively. Reference number 301 denotes the platen serving as the conveyance mechanism. The reference number 304 denotes the thermal head for printing. In FIGS. 3A and 3B, the movable blade 303 is in the position where cutting the continuous paper has been terminated.

Thus, according to the first embodiment, the movable blade 106 and the fixed blade 105 nip and cut the continuous paper.

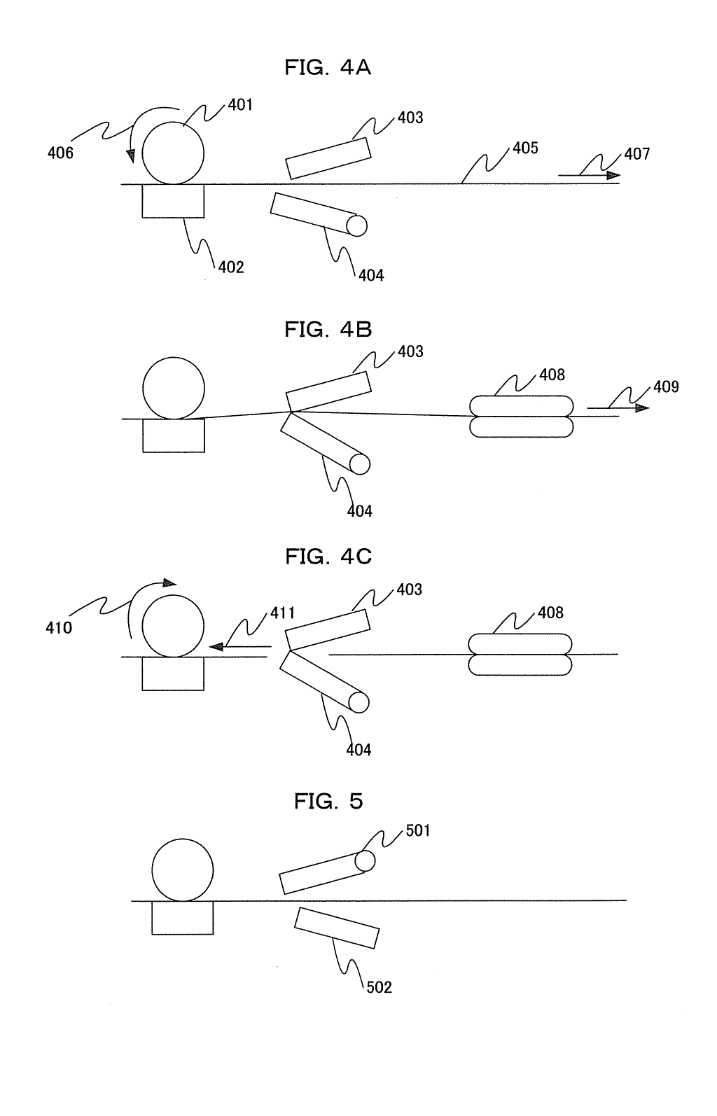

FIG. 4A illustrates the state in which the continuous paper cutting apparatus according to the first embodiment conveys the continuous paper in the direction of the arrow 407 before the continuous paper is cut. At this time, the movable blade 404 is in the initial position. As the platen 401 is rotated in the direction of the arrow 406, the continuous paper 405 is passed between the thermal head 402 and the platen 401, which serves as the conveyance mechanism, and then between the fixed blade 403 and movable blade 404, and further conveyed in the direction of the arrow 407.

FIG. 4B illustrates the state in which the cutting apparatus has started the cutting of the continuous paper 405. Specifically, the movable blade 404 has been driven toward the fixed blade 403 so that the movable blade 404 and the fixed blade 403 nip the continuous paper 405. At this time, the tensioning unit 408 which has the belt conveyor mechanism tensions the continuous paper 405 by drawing the continuous paper in the direction of the arrow 409 indicating the direction of ejection of the continuous paper 405. The tensioning unit is located on the side where the continuous paper will be ejected once cut, and nips both surfaces of the continuous paper.

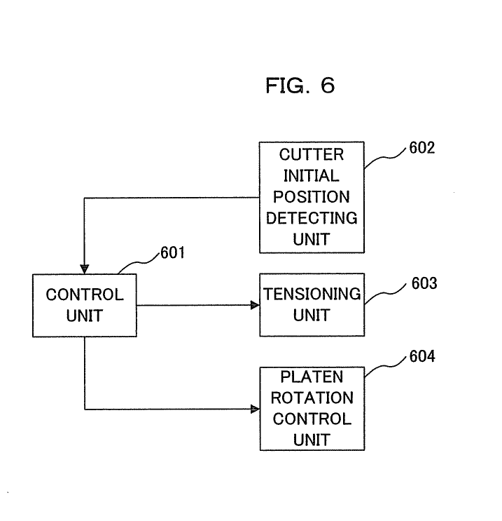

Tensioning the continuous paper is synchronized with the starting of a motor for driving the cutter. At this time, a control unit 601 (described below) shown in FIG. 6, operates the tensioning unit in the direction in which the continuous paper is drawn from the cutter.

FIG. 4C illustrates the state in which the continuous paper cutting apparatus of the first embodiment has terminated the cutting of the continuous paper 405. When the position detection sensor 110 determines from the position detection gear 101 that the cutter is in the cutting-termination position, the control unit 601 (described below) operates the conveyance mechanism in the direction in which the continuous paper is withdrawn from the cutter. To be specific, the control unit 601 withdraws the continuous paper from the cutter by rotating the platen 401 in the direction of the arrow 410. This prevents the cutter returning to its initial position from touching the surface of the continuous paper. Accordingly, this avoids the cutter blade's scraping the surface of the continuous paper and producing paper dust. Tensioning the continuous paper terminates when the continuous paper is withdrawn from the cutter.

The above description specifies the configuration in which the movable blade 106 is located below the continuous paper. However, the operation is the same in the configuration in which the movable blade 501 is disposed above and the fixed blade 502 below the continuous paper, as shown in FIG. 5.

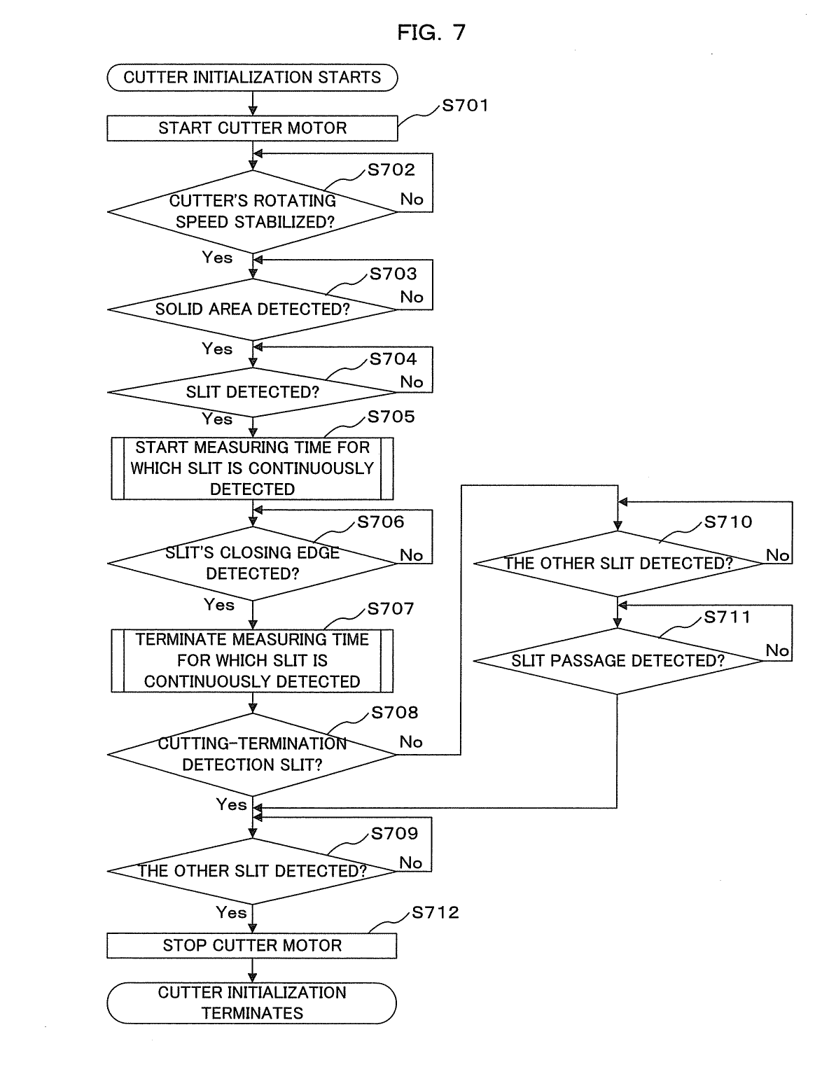

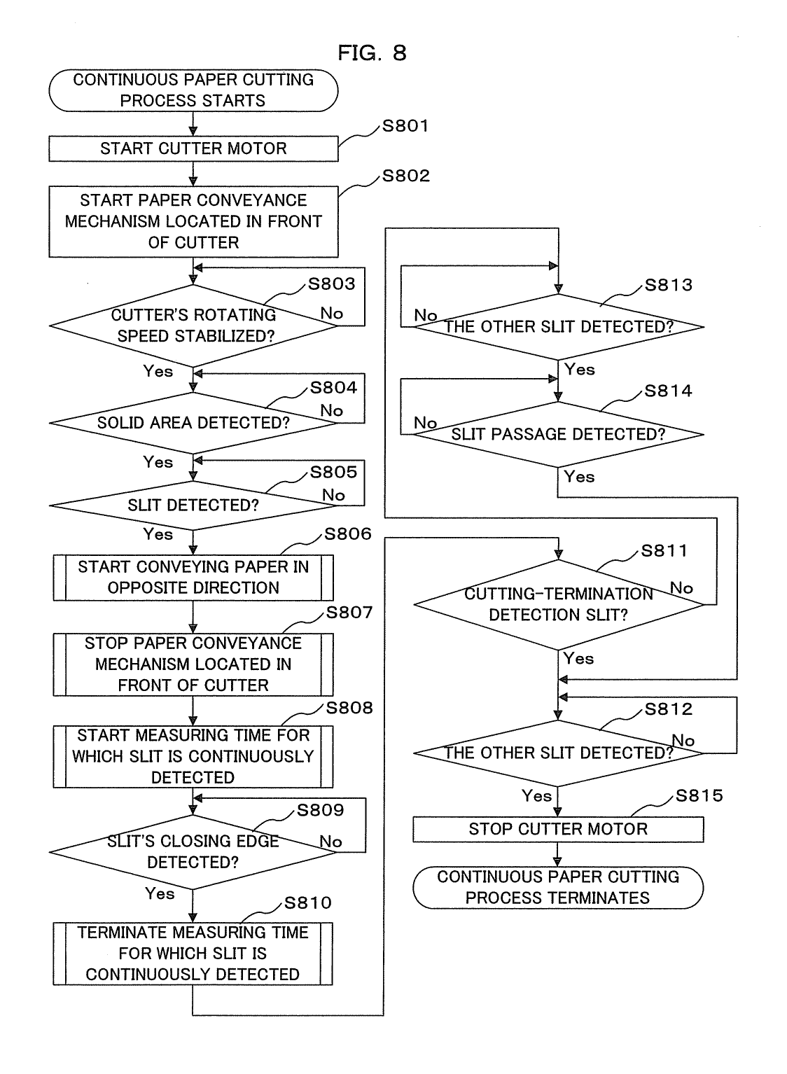

FIG. 6 is a block diagram showing a control device provided for the cutting apparatus of the first embodiment. The control device includes the control unit 601 for controlling various units, a cutter initial position detecting unit 602 having the position detection sensor 110 and which detects the initial position of the cutter, a tensioning unit 603 which tensions continuous paper to be cut, and a platen rotation control unit 604 which controls rotation of the platen serving as the conveyance mechanism. Upon determining that the cutter is in the initial position or cutting-termination position, the cutter initial position detecting unit 602 transmits a signal to the control unit 601. Based on the signal received from the cutter initial position detecting unit 602, the control unit 601 determines whether the cutter is in the initial position or cutting termination position. The determining method will be described below with reference to FIGS. 7 and 8.

The control unit 601 controls the tensioning unit 603 such that, in the continuous paper cutting process, the tensioning unit 603 initiates the tensioning of the continuous paper in synchronization with the starting of the motor for driving the cutter.

When it has determined that the signal received indicates the cutting-termination position of the cutter, the control unit 601 transmits a signal to the tensioning unit 603 in order that the tensioning unit 603 terminate tensioning continuous paper, and a signal to the platen rotation control unit 604 in order that the unit 604 rotate the platen in the direction where the continuous paper is withdrawn from the cutter.

Additionally, the control unit 601 controls the motor for driving the position detection gear 101, which is a gear for driving the cutter.

FIG. 7 is a flowchart illustrating the cutter position initialization process performed by the continuous paper cutting apparatus of the first embodiment. In this embodiment, the cutter position and the continuous paper position are controlled. Accordingly it is necessary for the control unit to perform the cutter initialization process of bringing the movable blade 106 into a predetermined cutting initialization alignment. The cutter initialization process is performed prior to the continuous paper cutting process (described below). Now, the cutter initialization process will be explained below.

In step S701, the control unit 601 starts the motor for driving the movable blade 106 of the cutter. At this time, the position detection gear 101 begins rotating in synchronization with the movable blade 106.

In step S702, the control unit 601 checks for the time required for the rotating speed of the cutter to stabilize. To be specific, the control unit 601 holds information about the fixed time obtained by a test or the like, which is the time taken by the cutter to stabilize; after the fixed time has elapsed, the control unit 601 proceeds to step S703.

In step S703, the control unit 601 checks whether the position detection sensor 110 has detected the solid area (here, the solid area is defined as a portion of the position detection gear 101 which is not the slit) of the position detection gear 101. If the sensor has detected the solid area, the control unit 601 proceeds to step S704. The purpose of step S703 is to avoid erroneous measurement of the width of either slit in the case where the slit portion is in the position of the sensor when the detecting sensor 110 starts slit detection.

In step S704, the control unit 601 checks whether the position detection sensor 110 has detected the cutting-termination detecting slit 109 or initial position detecting slit 108. The control unit 601 continues checking until either one of the slits is detected. When one of the slits has been detected, the control unit 601 proceeds to step S705.

Next, in step S705, the control unit 601 begins to measure the time for which the position detection sensor 110 continuously detects the slit, specifically, the time for which light passes through the slit.

In step S706, the control unit 601 checks whether the position detection sensor 110 has detected the closing edge of the slit, specifically whether the sensor has detected the termination of the passage of light through the slit. If the sensor 110 has detected the closing edge of the slit, the control unit 601 goes to step S707.

In step S707, the control unit 601 terminates the measurement of time for which the position detection sensor 110 continuously detects the slit, specifically the time for which light passes through the slit.

In step S708, based on the time measured from steps S705 to S707, the control unit 601 determines whether the slit detected is the cutting-termination detecting slit 109 or not. If the determination is affirmative, the control unit 601 goes to step S709. If negative, the unit 601 goes to step S710.

In step S710, the control unit 601 checks whether the position detection sensor 110 has detected the other slit. If the sensor 110 has detected the other slit, the control unit 601 proceeds to step S711.

In step S711, the control unit 601 checks whether the position detection sensor 110 has detected the passage of the slit detected in step S710. If the slit detected in step S710 has passed the sensor 110, the control unit 601 proceeds to step S709.

Thus, in steps S710 and 711, the control unit 601 skips the slit which is not the cutting-termination detecting slit 109.

Subsequently, in step S709, the control unit 601 checks whether the position detection sensor 110 has detected the other slit, namely the initial-position detecting slit 108.

In step S712, the control unit 601 stops the motor for driving the movable blade 106 of the cutter. At this time, in synchronization with the movable blade 106, the position detection gear 101 also stops rotation.

FIG. 8 is a flowchart illustrating the continuous paper cutting process of the continuous paper cutting apparatus of the first embodiment. The continuous paper cutting process is performed as if the case were that the cutter initialization process has finished. However, even if the cutter initialization process has not finished, the flowchart is drawn so that the cutter terminates the process in the initial position. The procedure of the continuous paper cutting process will be described below.

In step S801, the control unit 601 starts the motor for driving the movable blade 106 of the cutter. At this time, the position detection gear 101 also starts rotation in synchronization with the movable blade 106.

Next, in step S802, the control unit 601 starts the drive of the paper conveyance mechanism (specifically, tensioning unit 603) located in front of the cutter.

In step S803, the control unit 601 monitors the time needed to stabilize the rotating speed of the cutter. Specifically, the control unit 601 holds information about the fixed time obtained by a test or the like, which is the time taken by the cutter to stabilize; after the fixed time has elapsed, the control unit 601 proceeds to step S804.

In step 804, the control unit 601 checks whether the position detection sensor 110 has detected the solid area of the position detection gear 101. If the sensor has detected the solid area, the control unit 601 proceeds to step S805. The purpose of step S804 is to allow the control unit 601 to determine that the cutter has started cutting continuous paper.

In step S805, the control unit 601 checks whether the position detection sensor 110 has detected the slit of the position detection gear 101. If the slit has been detected, the control unit 601 proceeds to step S806. The purpose of step S805 is to allow the control unit 601 to determine that the cutter has terminated cutting the continuous paper.

In step S806, the control unit 601 starts conveying the continuous paper in the opposite direction. To be specific, the control unit 601 operates the platen rotation control unit 604, which is the conveyance mechanism for controlling the rotation of the platen, such that the continuous paper is withdrawn from the cutter.

In step S807, the control unit 601 stops the drive of the paper conveyance mechanism (specifically, tensioning unit 603) located in front of the cutter.

Subsequently, in step S808, the control unit 601 starts measuring the time for which the position detection sensor 110 continuously detects the slit, specifically, the time for which light passes through the slit.

In step S809, the control unit 601 checks whether the position detection sensor 110 has detected the closing edge of the slit, specifically whether the sensor no longer detects the passage of the light through the slit. If the sensor 110 has detected the closing edge of the slit, the control unit 601 goes to step S810.

In step S810, the control unit 601 terminates the measurement of time for which the position detection sensor 110 continuously detects the slit, specifically, the time for which light passes through the slit.

Next, in step S811, the control unit 601 determines whether the slit detected based on the time measured from steps S808 to 810 is the cutting-termination slit 109 or not. If the slit thus detected is the cutting-termination slit 109, the control unit 601 proceeds to step S812. If not, the control unit 601 proceeds to step S813.

In step S813, the control unit 601 checks whether the position detection sensor 110 has detected the other slit. If the sensor 110 has detected the other slit, the control unit 601 proceeds to step S814.

In step S814, the control unit 601 checks whether the position detection sensor 110 has detected the passage of the slit detected in step S813. If the slit detected has passed the sensor 110, the control unit 601 proceeds to step S812.

Thus in steps S813 and S814, the control unit 601 skips the slit which is not the cutting-termination slit 109.

Subsequently, in step S812, the control unit 601 checks whether the position detection sensor 110 has detected the other slit, namely, the initial-position detecting slit 108. If the sensor 110 has detected the initial-position detecting slit 108, the control unit 601 proceeds to step S815.

In step S815, the control unit 601 stops the motor for driving the movable blade 106 of the cutter. At this time, in synchronization with the movable blade 106, the position detection gear 101 also stops rotation.

According to the continuous paper cutting apparatus of the first embodiment, when the position detection sensor has sensed from the position detection gear that the movable blade is in the cutting termination position, the control unit operates the conveyance mechanism in the direction in which continuous paper is withdrawn from the cutter. This ensures the appropriate timing of withdrawing the paper from the cutter. Accordingly, the cutter returning to its initial position is prevented from touching the surface of the continuous paper. This avoids the cutter blade's scraping the surface of the continuous paper and producing paper dust. Furthermore, the continuous paper cutting apparatus of the first embodiment uses an inexpensive DC motor to drive the cutter, that is to say the position detection gear 101. This makes it possible to manufacture the cutting apparatus at low cost.

### Second Embodiment

In a continuous paper cutting apparatus according to the second embodiment of the present invention, a stepping motor is adopted as a cutter motor, specifically as a drive motor for driving the position detection gear 101.

The configuration of the second embodiment is identical to that of the first embodiment except for the position detection gear 101.

In the position detection gear 101 of the second embodiment, the number of initial position detecting slits must be at least one, namely slit 108. The continuous paper cutting apparatus according to the second embodiment determines the cutting termination position by counting the number of steps by which the stepping motor is driven.

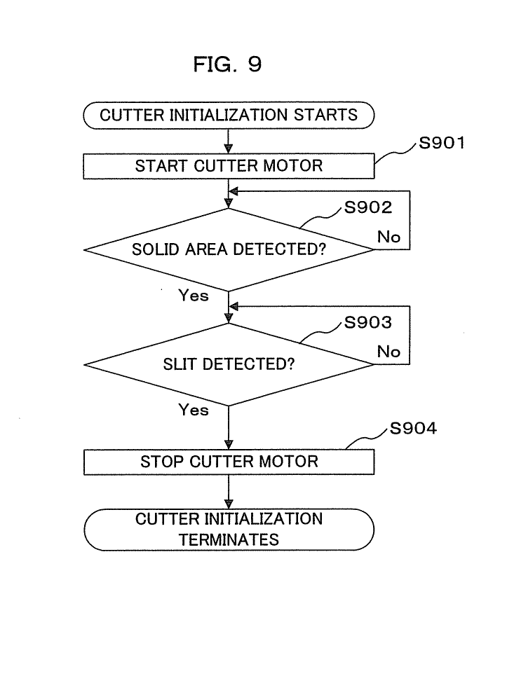

FIG. 9 is a flowchart illustrating the cutter position initialization process performed by the continuous paper cutting apparatus of the second embodiment. In order to control the cutter position and the continuous paper position, the present embodiment performs the cutter initialization process of bringing the movable blade 106 into a predetermined cutting initialization alignment. The cutter initialization process is performed prior to a continuous paper cutting process (described below). While the continuous paper is being cut, the conveyance of the continuous paper is stopped. The procedure of the cutter position initialization process will now be described.

In step S901, the control unit 601 starts the motor for driving the movable blade 106 of the cutter. At this time, the position detection gear 101 begins rotating in synchronization with the movable blade 106.

In step S902, the control unit 601 checks whether the position detection sensor 110 has detected the solid area of the position detection gear 101. If the sensor has detected the solid area, the control unit 601 proceeds to step S903.

In this step, by detecting the solid area, the control unit 601 determines that the slit has passed out of the detectable area of the detecting sensor 110. The purpose of step S903 is to confirm that the cutter is rotating. If the control unit 601 cannot detect rotation of the cutter, the cutter may be determined to be in an abnormal state.

In step S908, the control unit 601 checks whether the position detection sensor 110 has detected the slit 108. The unit 601 continues checking until the slit is detected. When the slit has been detected, the control unit 601 proceeds to step S904.

Subsequently, in step S904, the control unit 601 stops the motor for driving the movable blade 106 of the cutter. At this time, in synchronization with the movable blade 106, the position detection sensor 110 also stops rotating.

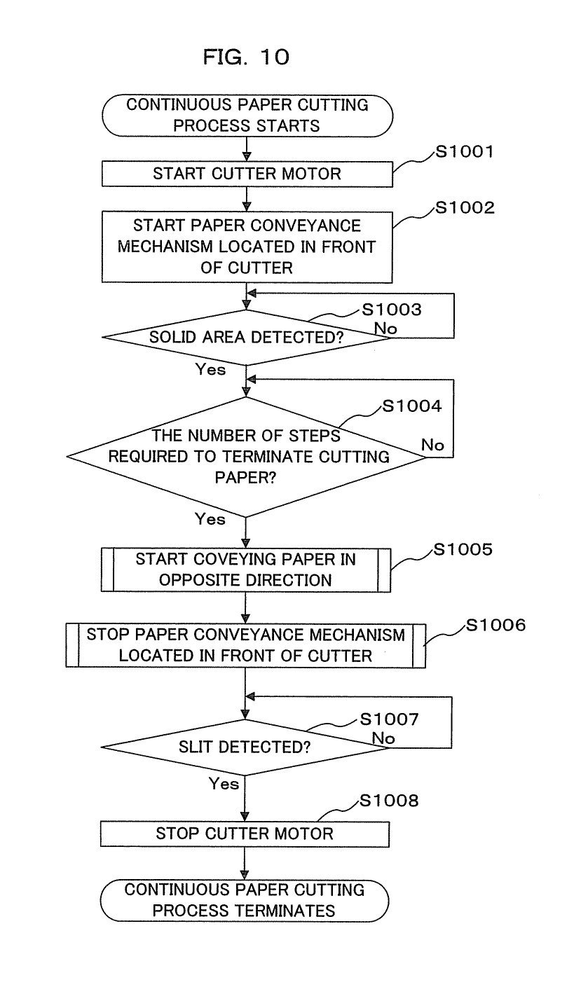

FIG. 10 is a flowchart illustrating the continuous paper cutting process of the cutting apparatus of the second embodiment. The continuous paper cutting process is performed as if the case were that the cutter initialization process has finished. However, even if the cutter initialization process has not finished, the flowchart is drawn such that the cutter terminates the process in the initial position. The procedure of the continuous paper cutting process will be described below.

In step S1001, the control unit 601 starts the motor for driving the movable blade 106 of the cutter, and also counts the number of steps by which the motor is driven. At this time, the rotation of the position detection gear 101 also starts in synchronization with the movable blade 106.

Next, in step S1002, the control unit 601 starts the drive of the paper conveyance mechanism (specifically, tensioning unit 603) located in front of the cutter.

In step S1003, the control unit 601 checks whether the position detection sensor 110 has detected the solid area of the position detection gear 101. If the sensor has detected the solid area, the control unit 601 proceeds to step S1004. The purpose of step S1003 is to allow the control unit 601 to determine that the cutter has started cutting continuous paper.

In step S1004, the control unit 601 checks whether the number of steps by which the motor was rotated in order to drive the movable blade 106 of the cutter has reached the predetermined number required to terminate cutting the continuous paper. If the number of steps has reached the predetermined number, the control unit 601 goes to step S1005.

In step S1005, the control unit 601 starts conveying the continuous paper in the opposite direction. Specifically, the control unit 601 operates the platen rotation control unit 604, which is the conveyance mechanism for controlling the rotation of the platen, such that the continuous paper is withdrawn from the cutter.

In step S1006, the control unit 601 stops the drive of the paper conveyance mechanism (specifically, tensioning unit 603) located in front of the cutter.

Subsequently, in step S1007, the control unit 601 checks whether the position detection sensor 110 has detected the slit of the position detection gear 101. If the sensor 110 has detected the slit, the control unit 601 goes to step S1008.

In step S1008, the control unit 601 stops the motor for driving the movable blade 106 of the cutter. At this time, in synchronization with the movable blade 106, the position detection gear 101 also stops rotation.

According to the continuous paper cutting apparatus of the second embodiment, when the position detection sensor has sensed from the position detection gear that the movable blade is in the cutting termination position, the control unit operates the conveyance mechanism in the direction in which the continuous paper is withdrawn from the cutter. This ensures that withdrawal of the continuous paper from the cutter occurs at an appropriate timing. Accordingly, the cutter returning to its initial position is prevented from touching the surface of the continuous paper. This avoids the cutter blade's scraping the surface of the continuous paper and producing paper dust. Further, a stepping motor as the motor for driving the cutter, that is to say the position detection gear 101 is adopted. Thus, the cutting apparatus can be controlled with fewer steps.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A continuous paper cutting apparatus comprising:
a cutter which cuts continuous paper;
a conveyance mechanism which conveys the continuous paper to the cutter;
a position detection gear which rotates in synchronization with the cutter;
a position detection sensor which detects the position of the cutter based on the rotated position of the position detection gear; and
a control unit which controls the conveyance mechanism so as to withdraw the continuous paper from the cutter when the position detection sensor detects that the cutter is in a cutting termination position.

2. A continuous paper cutting apparatus comprising:
a cutter which cuts continuous paper, the cutter including a fixed blade and a movable blade;
a tensioning unit which applies tension to the continuous paper, the tensioning unit being aligned with the cutter on the side where the continuous paper will be ejected once cut;
a position detection gear which rotates in synchronization with the cutter;
a position detection sensor which detects the position of the movable blade based on the rotated position of the position detection gear; and
a control unit which controls the tensioning unit so as to draw the continuous paper through the cutter when a motor starts to drive the cutter, and controls a conveyance mechanism so as to withdraw the continuous paper from the cutter when the position detection sensor detects that the cutter is in a cutting termination position.

3. A continuous paper cutting apparatus according to claim 1, wherein the movable blade is located above continuous paper to be cut and the fixed blade is located below the continuous paper.

4. A continuous paper cutting apparatus according to claim 2, wherein the movable blade is located above continuous paper to be cut and the fixed blade is located below the continuous paper.

5. A continuous paper cutting apparatus according to claim 1, wherein the movable blade is located below continuous paper to be cut and the fixed blade is located above the continuous paper.

6. A continuous paper cutting apparatus according to claim 2, wherein the movable blade is located below continuous paper to be cut and the fixed blade is located above the continuous paper.

7. A continuous paper cutting apparatus comprising:
a cutter which cuts continuous paper, the cutter including a fixed blade and a movable blade;
a tensioning unit which applies tension to the continuous paper, the tensioning unit being aligned with the cutter on the side where the continuous paper will be ejected once cut;
a conveyance mechanism which conveys the continuous paper to the cutter;
a position detection gear which rotates in synchronization with the movable blade of the cutter, the position detection gear having a first slit indicating the initial position of the movable blade and a second slit indicating the cutting-termination position of the movable blade;
a DC motor which drives the position detection gear;
a position detection sensor which detects the first and second slits of the position detection gear; and
a control unit which controls the tensioning unit so as to draw the continuous paper through the cutter when a motor starts to drive the cutter, and controls the conveyance mechanism so as to withdraw the continuous paper from the cutter when the position detection sensor detects the second slit.

8. A continuous paper cutting apparatus according to claim 7, wherein the movable blade is located above continuous paper to be cut and the fixed blade is located below the continuous paper.

9. A continuous paper cutting apparatus according to claim 8, wherein the movable blade is located below continuous paper to be cut and the fixed blade is located above the continuous paper.

10. A continuous paper cutting apparatus comprising:
a cutter which cuts continuous paper, the cutter including a fixed blade and a movable blade;
a tensioning unit which applies tension to the continuous paper, the tensioning unit being aligned with the cutter on the side where the continuous paper will be ejected once cut;
a conveyance mechanism which conveys the continuous paper to the cutter;
a position detection gear which rotates in synchronization with the movable blade of the cutter, the position detection gear having a slit indicating the initial position of the movable blade;
a stepping motor which drives the position detection gear;
a position detection sensor which detects the slit of the position detection gear; and
a control unit which controls the tensioning unit so as to draw the continuous paper through the cutter when a motor starts to drive the cutter, and controls the conveyance mechanism so as to withdraw the continuous paper from the cutter when the movable blade is detected to be in a cutting termination position from the number of steps by which the stepping motor has been driven.

11. A continuous paper cutting apparatus according to claim 10, wherein the movable blade is located above continuous paper to be cut and the fixed blade is located below the continuous paper.

12. A continuous paper cutting apparatus according to claim 11, wherein the movable blade is located below continuous paper to be cut and the fixed blade is located above the continuous paper.

13. A continuous paper cutting method for cutting continuous paper with a cutter including a fixed blade and a movable blade, the method comprising:
a step for conveying the continuous paper to the cutter; and
a step for withdrawing the continuous paper in the direction opposite to the direction of conveyance of the continuous paper when the termination of cutting the continuous paper with the movable blade is detected from a rotation angle of a position detection gear which rotates in synchronization with the movable blade.

14. A continuous paper cutting method for cutting continuous paper with a cutter including a fixed blade and a movable blade, the method comprising:
a step for conveying the continuous paper to the cutter;
a step for applying tension, when a motor starts to drive the cutter, to the continuous paper in the direction in which the continuous paper will be ejected once cut; and
a step for withdrawing, when termination of cutting the continuous paper with the movable blade is detected from a rotation angle of a position detection gear which rotates in synchronization with the movable blade, the continuous paper in the direction opposite to the direction of conveyance of the continuous paper.

15. A continuous paper cutting method according to claim 14, wherein
the position detection gear comprises a first slit indicating the initial position of the movable blade and a second slit indicating the position of termination of cutting the continuous paper with the movable blade, the second slit having a width different from a width of the first slit in the rotating direction, and
in the step for withdrawing, the width of the second slit is detected temporally to withdraw the continuous paper in the direction opposite to the direction of conveyance of the continuous paper.
